(19) United States
(12) Patent Application Publication
(10) Pub. No.: US 2026/0222703 A1
(43) Pub. Date: Jul. 30, 2026

(54) VOLTAGE CONVERSION CIRCUIT AND IMAGE SENSING DEVICE INCLUDING THE SAME

(71) Applicant: SK hynix Inc., Gyeonggi-do (KR)

(72) Inventors: Min Kyu KIM, Gyeonggi-do (KR); Dong Ju KIM, Gyeonggi-do (KR); Jeong Hoon KIM, Gyeonggi-do (KR); Ho Young PARK, Gyeonggi-do (KR); Jin Seok LEE, Gyeonggi-do (KR)

(21) Appl. No.: 19/455,847

(22) Filed: Jan. 22, 2026

(30) Foreign Application Priority Data
Jan. 24, 2025 (KR) 10-2025-0011300
Dec. 4, 2025 (KR) 10-2025-0190566

(51) Int. Cl. H04N 25/709; H02M 3/07; H04N 23/71; H04N 25/60

(52) U.S. Cl. CPC H04N 25/709; H02M 3/07; H04N 23/71; H04N 25/60

(57) ABSTRACT

An image sensing device capable of generating image data is disclosed. The voltage conversion circuit includes a pump circuit configured to pump a bias voltage and generate a pumping voltage; and a regulator configured to regulate the pumping voltage and generate an output voltage, wherein the pump circuit is configured to vary the pumping voltage by adjusting a pumping capacitance based on an intensity of light.

### CROSS-REFERENCE TO RELATED APPLICATIONS

This patent document claims the priority and benefits of Korean patent application Nos. 10-2025-0011300 filed on January 24, 2025 and 10-2025-0190566 filed on December 4, 2025, the disclosures of which are incorporated herein by reference in its entirety as part of the disclosure of this patent document.

### TECHNICAL FIELD

The technology and implementations disclosed in this patent document generally relate to an image sensing device capable of generating image data.

### BACKGROUND

Complementary metal oxide semiconductor (CMOS) image sensors (CISs) are implemented by a CMOS process and have been developed to have lower power consumption, lower costs, and smaller sizes than other competitive products. CMOS image sensors (CISs) have been intensively researched and have rapidly come into widespread use. Specifically, CMOS image sensors (CISs) have been developed to have higher image quality than other competitive products, such that the application scope of CMOS image sensors (CISs) has recently been extended to video applications that require higher resolution and higher frame rate as compared to competitive products.

In order to reduce power consumption of CMOS image sensors (CISs), development efforts have been directed toward CISs that use low voltages for pixels and analog circuits. However, when multiple supply voltages having different levels (e.g., an analog power- supply voltage VDDA, an input/output power-supply voltage VDDIO, and a digital logic power-supply voltage VDDD) are used, a power management system becomes complex, and it may be difficult toadaptively control an image sensor according to operating conditions.

### SUMMARY

Various embodiments of the present disclosure relate to an image sensing device capable of reducing power consumption while suppressing noise by adaptively controlling a size of a pumping capacitor of a voltage conversion circuit according to the intensity of light.

Various embodiments of the present disclosure relate to an image sensing device capable of securing a voltage margin according to an analog gain and reducing temporal noise by adjusting a bias current of an analog-to-digital conversion (ADC) circuit based on an analog gain of a pixel signal.

In accordance with an embodiment of the present disclosure, a voltage conversion circuit may include: a pump circuit configured to pump a bias voltage and generate a pumping voltage; and a regulator configured to regulate the pumping voltage and generate an output voltage, wherein the pump circuit is configured to vary the pumping voltage by adjusting a pumping capacitance based on an intensity of light.

In accordance with another embodiment of the present disclosure, an image sensing device may include: a pixel array configured to output a pixel signal corresponding to an incident light; a voltage conversion circuit configured to charge and pump a bias voltage to generate a pumping voltage, and configured to vary the pumping voltage by adjusting a pumping capacitance according to a control signal; an analog-to-digital conversion (ADC) circuit configured to sample and hold the pixel signal, convert the pixel signal into a digital signal, and output the digital signal; and an image signal processor configured to control the control signal in response to an intensity of the incident light.

It is to be understood that both the foregoing general description and the following detailed description of the present disclosure are illustrative and explanatory and are intended to provide further explanation of the disclosure as claimed.

### BRIEF DESCRIPTION OF THE DRAWINGS

The above and other features and beneficial aspects of the present disclosure will become readily apparent with reference to the following detailed description when considered in conjunction with the accompanying drawings.

FIG. 1 is a schematic diagram illustrating an image sensing device according to an embodiment of the present disclosure.

FIG. 2 is an example circuit diagram illustrating a pixel shown in FIG. 1 according to an embodiment of the present disclosure.

FIG. 3 is a detailed block diagram illustrating a voltage conversion circuit shown in FIG. 1 according to an embodiment of the present disclosure.

FIGS. 4A and 4B are detailed circuit diagrams illustrating the pump circuit shown in FIG. 3 according to an embodiment of the present disclosure.

FIG. 5 is a graph illustrating the relationship between noise and a sensor output signal according to the intensity of light according to an embodiment of the present disclosure.

FIG. 6 is a graph illustrating the relationship between negative currents according to the intensity of light when light is incident upon a sensor, according to an embodiment of the present disclosure.

FIG. 7 is a graph illustrating the relationship between the intensity of light and negative voltages that change depending on the number of pumping capacitors according to an embodiment of the present disclosure.

FIG. 8 is a block diagram illustrating an electronic device according to an embodiment of the present disclosure.

FIG. 9A is a circuit diagram illustrating an analog-to-digital conversion (ADC) circuit shown in FIG. 8 according to an embodiment of the present disclosure.

FIG. 9B is a detailed circuit diagram illustrating a comparator shown in FIG. 9A according to an embodiment of the present disclosure.

FIG. 10 is a circuit diagram illustrating a bias voltage generation circuit and a comparison circuit shown in FIG. 8 according to an embodiment of the present disclosure.

FIG. 11 is a graph illustrating the relationship between temporal noise and analog gain according to an embodiment of the present disclosure.

FIG. 12 is a graph illustrating the relationship between analog gain and counter output signals according to an embodiment of the present disclosure.

### DETAILED DESCRIPTION

The present disclosure provides implementations and examples of an image sensing device capable of generating image data that may be used in configurations to substantially address one or more technical or engineering issues and to mitigate limitations or disadvantages encountered in some other image sensing devices. Some implementations of the present disclosure relate to an image sensing device capable of reducing power consumption while suppressing noise by adaptively controlling a size of a pumping capacitor of a voltage conversion circuit according to the intensity of light. Some implementations of the present disclosure relate to an image sensing device capable of securing a voltage margin according to an analog gain and reducing temporal noise by adjusting a bias current of an analog-to-digital conversion (ADC) circuit based on the analog gain of a pixel signal. In recognition of the issues above, the image sensing device according to the embodiments of the present disclosure may adaptively control a size of a pumping capacitor of a voltage conversion circuit according to the intensity of light, thereby securing high driving capability in a high-illuminance (or bright) environment and minimizing output ripples of the voltage conversion circuit in a low-illuminance (or dark) environment. The image sensing device may secure a voltage margin according to an analog gain and reduce temporal noise by adjusting a bias current of the ADC circuit based on the analog gain of a pixel signal.

Reference will now be made in detail to the embodiments of the present disclosure, examples of which are illustrated in the accompanying drawings. Wherever possible, the same reference numbers will be used throughout the drawings to refer to the same or like parts. While the disclosure is susceptible to various modifications and alternative forms, specific embodiments thereof are shown by way of example in the drawings. However, the disclosure should not be construed as being limited to the embodiments set forth herein.

Hereinafter, various embodiments will be described with reference to the accompanying drawings. However, it should be understood that the present disclosure is not limited to specific embodiments, but includes various modifications, equivalents and/or alternatives of the embodiments. The embodiments of the present disclosure may provide a variety of effects capable of being directly or indirectly recognized through the present disclosure.

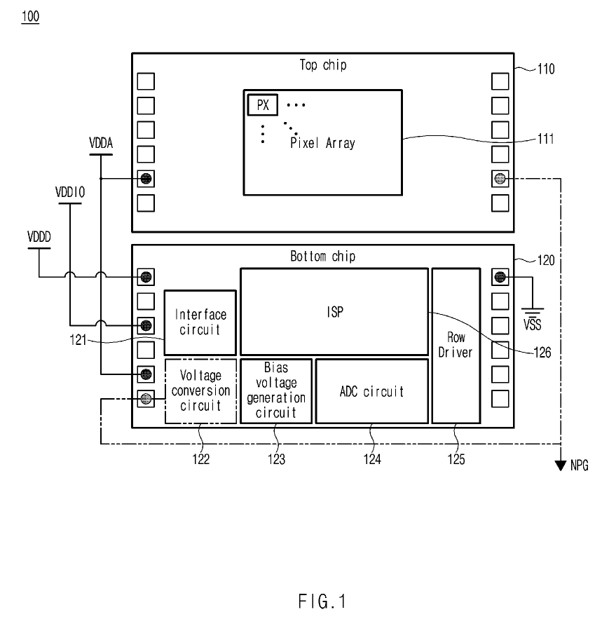

FIG. 1 is a schematic diagram illustrating an image sensing device 100 according to an embodiment of the present disclosure.

Referring to FIG. 1, the image sensing device 100 may include a stacked CMOS image sensor (e.g., a stacked CIS). The image sensing device 100 may include a top chip 110 and a bottom chip 120. In some embodiments, the top chip 110 may be stacked over the bottom chip 120.

As high-resolution and high-frame-rate image sensing devices 100 have been widely adopted in mobile smartphone applications, the image sensing devices 100 consume a large amount of power. To reduce power consumption, low voltages may be applied to pixels and analog circuits.

By way of example, the image sensing device 100 may use two power-supply voltage levels. For example, the power-supply voltage (VDDA) may have a first voltage level, and the power-supply voltage (VDDIO) may have the same first voltage level as the power- supply voltage (VDDA). In addition, the digital logic power-supply voltage (VDDD) may have a second voltage level different from the first voltage level (e.g., lower than the first voltage level). As the power- supply voltages having the same level are used as the power-supply voltages (VDDA, VDDIO), complexity of power management may be reduced and power consumption of pixels and analog circuits may be decreased.

In addition, the image sensing device 100 may be designed to use a negative voltage (e.g., a negative pixel ground NPG). For example, the negative voltage (NPG) may have a negative voltage level lower than zero volts (0 V).

The top chip 110 may include a pixel array 111. The pixel array 111 may include a plurality of pixels (PXs) arranged in a plurality of rows and a plurality of columns.

For example, the plurality of pixels (PXs) may be arranged in a two-dimensional (2D) pixel array 111 including rows and columns. In another example, a plurality of unit image pixels may be arranged in a three-dimensional (3D) pixel array 111.

The plurality of pixels (PXs) may convert optical signals into electrical signals on a pixel basis or on a pixel group basis, and pixels (PXs) within each pixel group may share at least one internal circuit.

The pixel array 111 may receive driving signals including a row selection signal, a pixel reset signal, and a transfer signal, from a row driver 125. A corresponding pixel (PX) of the pixel array 111 may be activated to perform operations corresponding to the row selection signal, the pixel reset signal, and the transfer signal based on the driving signals.

The bottom chip 120 may include an interface circuit 121, a voltage conversion circuit 122, a bias voltage generation circuit 123, an analog-to-digital conversion (ADC) circuit 124, the row driver 125, and an image signal processor (ISP) 126.

In the present embodiments, a plurality of conceptual hardware components included in the bottom chip 120 is illustrated for convenience of description; however, the embodiments described herein are not limited thereto, and other configurations are also possible.

The interface circuit 121 may perform data communication between constituent components within the image sensing device 100. The interface circuit 121 may transmit data (e.g., pixel data, image data, etc.) generated by or stored in the image sensing device 100 to each component (e.g., the ISP 126).

By way of example, the interface circuit 121 may input and output data using a Mobile Industry Processor Interface (MIPI). The MIPI alliance is an alliance companies aimed at standardizing interfaces for portable devices, and covers various topics including cameras, displays, audio, and buses. In the present disclosure, the interface circuit 121 may use MIPI; however, the scope of the present disclosure is not limited thereto, and various other interfaces may also be used as needed.

The voltage conversion circuit 122 may convert an input voltage based on a control signal of the ISP 126 to supply power-supply voltages to respective components of the image sensing device 100. The voltage conversion circuit 122 may convert the input voltage to generate a negative voltage (NPG). The negative voltage (NPG) generated by the voltage conversion circuit 122 may be provided to the pixel array 111.

For example, the voltage conversion circuit 122 may include a DC-DC converter. When an input voltage having a relatively high voltage level is applied to the DC-DC converter, the DC-DC converter may convert the input voltage into an output voltage having a relatively low voltage level, and may output the resultant low-level voltage.

In the present disclosure, in the voltage conversion circuit 122 configured to generate the negative voltage (NPG), the magnitude of pumping capacitance of a pump circuit in the voltage conversion circuit 122 may be adaptively varied according to illuminance. A detailed configuration and operation of the voltage conversion circuit 122 will be described later with reference to the drawings to be described below.

The bias voltage generation circuit 123 may convert a reference bias current into a voltage. The bias voltage generation circuit 123 may provide the generated bias voltage to components (e.g., the voltage conversion circuit 122 and/or the ADC circuit 124) included in the image sensing device 100.

The ADC circuit 124 may sample and hold pixel signals for respective columns output from each column line of the pixel array 111, may convert the sampled signals into digital signals, and may output the resultant digital signals. In one embodiment, the ADC circuit 124 may include a single-slope ADC; however, the present disclosure is not limited thereto. In one embodiment, the ADC circuit 124 may be implemented as a ramp-compare type ADC using a ramp signal generated by a ramp signal generator (e.g., a ramp signal generator 834 to be described later).

In the present embodiment, image data generated by the ADC circuit 124 may have at least two different sensitivities. Here, the sensitivity may mean an increase in amount of image data (or an increase amount of a response) with respect to an increase in intensity of incident light. That is, as the sensitivity increases, the amount of increase in image data in response to an increase in the intensity of incident light increases. As the sensitivity decreases, the amount of increase in image data in response to an increase in the intensity of incident light decreases.

Here, the sensitivity may be determined by the analog gain. The analog gain may refer to a ratio of a voltage level of an analog pixel signal varying depending on the intensity of the incident light to the size of the image data.

The row driver 125 may activate the pixel array 111 to cause pixels (PX) corresponding to a selected row to perform specific operations based on a control signal of the ISP 126 (and/or a control signal of a timing controller.

The row driver 125 may select at least one pixel (PX) arranged in at least one row of the pixel array 111. The row driver 125 may generate a row selection signal to select at least one row among a plurality of rows.

The row driver 125 may sequentially activate (for example, enable) a pixel reset signal and a transfer signal for pixels corresponding to the at least one selected row. Accordingly, a reference signal and an image signal, which are analog signals generated by each of the pixels of the selected row, may be sequentially transferred to the ADC circuit 124.

The reference signal may be an electrical signal that is provided to the ADC circuit 124 when a sensing node of a pixel (e.g., a floating diffusion region) is reset. The image signal may be an electrical signal that is provided to the ADC circuit 124 when photocharges generated by the pixel are accumulated in the sensing node. The reference signal indicating unique reset noise of each pixel and the image signal indicating the intensity of incident light may be generically referred to as a pixel signal.

The ISP 126 may perform image signal processing on the image data. The ISP 126 may reduce noise in the image data, and may perform various kinds of image signal processing, such as interpolation, synthesis, gamma correction, color filter array interpolation, color matrix, color correction, color enhancement, and lens distortion correction, for image-quality improvement of the image data.

The ISP 126 may compress image data that has been created by execution of image signal processing for image-quality improvement, such that the ISP 126 can create an image file using the compressed image data. Alternatively, the ISP 126 may recover image data from the image file. In this case, the format for compressing such image data may be a reversible format or an irreversible format. As an example of the compression format, for a still image, Joint Photographic Experts Group (JPEG) format, JPEG 2000 format, or the like may be used. In addition, for moving images, a plurality of frames may be compressed according to Moving Picture Experts Group (MPEG) standards to create moving image files. For example, image files may be created according to Exchangeable image file format (Exif) standards.

The ISP 126 may generate a high dynamic range (HDR) image by synthesizing at least two images having different sensitivities. For example, the image sensing device 100 may output a low- sensitivity image generated from a low-sensitivity pixel with a relatively lower sensitivity and a high-sensitivity image generated from a high- sensitivity pixel with a relatively higher sensitivity. The ISP 126 may combine the low-sensitivity image and the high-sensitivity image, resulting in formation of an HDR image. Here, the low-sensitivity and the high-sensitivity may correspond to relative concepts, and the image sensing device 100 may generate image data having at least N different sensitivities (where 'N' is an integer of 2 or more). The ISP 126 may generate HDR images using the image data.

The ISP 126 may transmit image-signal-processed (ISP) image data to a host device. The host device may be a processor (e.g. an application processor) for processing the ISP image data received from the ISP 126, a memory (e.g. a nonvolatile memory) for storing the ISP image data, or a display device (e.g. a liquid crystal display (LCD)) for visually displaying the ISP image data.

The ISP 126 may generate a control signal for controlling operations (whether or not to operate, an operation timing, an operation mode, etc.) of the image sensing device 100. To generate such control signals, the ISP 126 may include a timing controller. In the present disclosure, an example in which the timing controller is included within the ISP 126 has been described. However, the present disclosure is not limited thereto, and the timing controller may be provided as a separate component outside the ISP 126.

The ISP 126 may generate a control signal (e.g., a signal for controlling the magnitude of a pumping capacitance) for adjusting a pumping capacitance of a pump circuit (e.g., a pump circuit 321 to be described later) of the voltage conversion circuit 122, and may transmit the control signal to the voltage conversion circuit 122. For example, when the intensity of light is relatively high (e.g., in a high- illuminance environment), the ISP 126 may generate a control signal for increasing the pumping capacitance of the pump circuit. When the intensity of light is relatively low (e.g., in a low-illuminance environment), the ISP 126 may generate a control signal for decreasing the pumping capacitance of the pump circuit. For example, the ISP 126 may estimate the intensity of light based on at least one of an average value of a pixel signal, an exposure time, and/or an analog gain of the pixel signal, and may control the control signal based on the estimated resuIt.

The ISP 126 may generate a control signal (e.g., a bias current control signal) for adjusting a bias current of a comparator (e.g., a comparator to be described later) of the ADC circuit 124, and may transmit the control signal to the ADC circuit 124. For example, when the analog gain is set to be relatively high, the ISP 126 may generate a control signal for relatively increasing the bias current of the comparator. For example, when the analog gain is set to be relatively low, the ISP 126 may generate a control signal for relatively decreasing the bias current of the comparator.

The configuration of the image sensing device 100 is not limited to that illustrated in FIG. 1, and at least some components may be omitted or at least one component may be added.

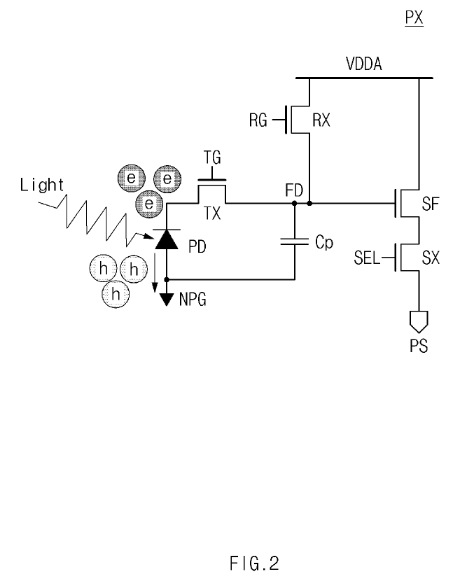

FIG. 2 is an example circuit diagram illustrating the pixel (PX) shown in FIG. 1 according to an embodiment of the present disclosure.

Referring to FIG. 2, the pixel (PX) may be any one of the plurality of pixels (PXs) included in the pixel array 111 illustrated in FIG. 1. In FIG. 2, a single pixel (PX) is described, but other pixels may have substantially the same structure and operation as the pixel (PX).

The pixel (PX) may include a photoelectric conversion element (PD), a transfer transistor (TX), a reset transistor (RX), a floating diffusion region (FD), a pixel capacitor (Cp), a source follower transistor (SF), and a selection transistor (SX).

In FIG. 2, the pixel (PX) is illustrated as including a single photoelectric conversion element (PD); however, the present disclosure is not limited thereto. For example, the pixel (PX) may be a shared pixel including a plurality of photoelectric conversion elements. The shared pixel (PX) may include a plurality of transfer transistors corresponding to the plurality of photoelectric conversion elements.

The photoelectric conversion element (PD) may generate and accumulate photocharges corresponding to the intensity of incident light. For example, the photoelectric conversion element (PD) may be implemented as a photodiode, a phototransistor, a photogate, a pinned photodiode, or a combination thereof. For example, when the photoelectric conversion element (PD) is implemented as a photodiode, the photoelectric conversion element (PD) may be a region doped with impurities of a second conductivity type (e.g., N-type) within a substrate having a first conductivity type (e.g., P-type).

The transfer transistor (TX) may be connected between the photoelectric conversion element (PD) and the floating diffusion region (FD). The transfer transistor (TX) may be turned on or turned off in response to a transfer signal (TG). The transfer transistor (TX) may be turned on by a transfer signal (TG) at a logic high level to transfer photocharges accumulated in the photoelectric conversion element (PD) to the floating diffusion region (FD).

The reset transistor (RX) may be connected between the floating diffusion region (FD) and an input terminal of the power-supply voltage (VDDA). The reset transistor (RX) may reset a voltage of the floating diffusion region (FD) to the power-supply voltage (VDDA) in response to a reset signal (RG) at a logic high level.

The floating diffusion region (FD) may accumulate photocharges received from the transfer transistor (TX). The floating diffusion region (FD) may be connected to a pixel capacitor (Cp) connected to a ground terminal.

For example, the floating diffusion region (FD) may be a region doped with impurities of a second conductivity type (e.g., N-type) within a substrate having a first conductivity type (e.g., P-type). The substrate and the impurity-doped region may be modeled as a pixel capacitor (Cp), which is a junction capacitor. The floating diffusion region (FD) may be referred to as a sensing node.

In the present disclosure, a logic high level may refer to a voltage level for activating (e.g., turning on) a corresponding device (e.g., a transistor), and a logic low level may refer to a voltage level for deactivating (e.g., turning off) the corresponding device.

In FIG. 2, the floating diffusion region (FD) has been described based on an embodiment having a single capacitance; however, the floating diffusion region (FD) may have two or more capacitances. For example, the floating diffusion region (FD) may be connected to a dual conversion gain (DCG) transistor to selectively receive additional capacitance, so that the floating diffusion region (FD) may have two capacitance values.

The source follower transistor (SF) may be connected between the selection transistor (SX) and an input terminal of the power-supply voltage (VDDA).

The source follower transistor (SF) may amplify a change in an electrical potential of the floating diffusion region (FD), which has received photocharges accumulated in the photoelectric conversion element (PD), and may transmit the amplified change to the selection transistor (SX).

The selection transistor (SX) may be connected between the source follower transistor (SF) and an output terminal of a pixel signal (PS). The selection transistor (SX) may be turned on by a selection control signal (SEL) to output an electrical signal received from the source follower transistor (SF) as the pixel signal (PS).

In some embodiments, the photoelectric conversion element (PD) may generate electron (e)-hole (h) pairs according to the intensity of light. The electrons (e) may be stored in the photoelectric conversion element (PD), and the holes (h) may flow toward a negative voltage (NPG) node and become a load current of the voltage conversion circuit 122. For example, as the intensity of light increases (e.g., as ambient light becomes brighter), a load current flowing into the voltage conversion circuit 122 may increase.

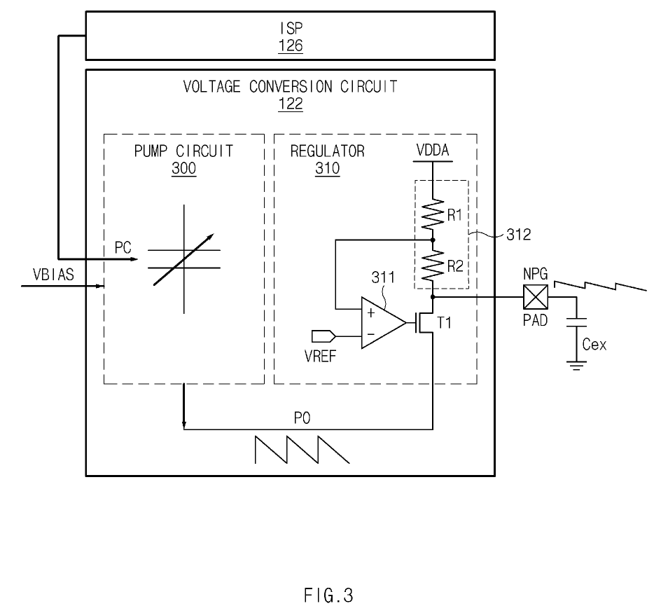

FIG. 3 is a detailed block diagram illustrating the voltage conversion circuit 122 shown in FIG. 1 according to an embodiment of the present disclosure.

Referring to FIG. 3, the voltage conversion circuit 122 may pump (step up or step down) an input bias voltage (VBIAS) to generate power-supply voltages (e.g., an analog power-supply voltage (VDDA), an input and output (input/output) power-supply voltage VDDIO, a digital logic power-supply voltage VDDD, and/or a negative voltage NPG) to be used in the image sensing device 100.

The voltage conversion circuit 122 may include a pump circuit 300 and a regulator 310. Hereinafter, descriptions overlapping with those of FIGS. 1 and 2 will be omitted or briefly described.

The pump circuit 300 may step up (or boost) or step down an input bias voltage (VBIAS) to generate a pumping voltage (PO). For example, the pump circuit 300 may include a plurality of pumping capacitors (described herein below) and a plurality of switches for controlling the plurality of pumping capacitors. As at least some of the switches connected to the plurality of pumping capacitors are turned on or off according to a control signal (PC) of the ISP 126, a pumping capacitance of the pump circuit 300 may be adjusted.

For example, when the intensity of light (e.g., external illuminance) increases (e.g., in a bright environment), the pumping capacitance of the pump circuit 300 may be adjusted to be relatively high. In contrast, when the intensity of light decreases (e.g., in a dark environment), the pumping capacitance of the pump circuit 300 may be adjusted to be relatively low.

The regulator 310 may generate either an output voltage having the same level as the pumping voltage (PO) or an output voltage having a lower level than the pumping voltage (PO) through regulation of the pumping voltage (PO). For example, the regulator 310 may regulate the pumping voltage (PO) to output a negative voltage (NPG).

The pumping voltage (PO) received from the pump circuit 300 may be stabilized. For example, the regulator 310 may reduce noise (e.g., readout noise, pixel pattern noise) of the power-supply voltage, and may remove ripple noise of an output signal of the pump circuit 300. The regulator 310 may include a low drop-out (LDO) regulator; however, the present disclosure is not limited thereto.

The regulator 310 may include a comparator 311, a voltage divider 312, and a switching circuit (T1).

The comparator 311 may compare a voltage of the voltage divider 312 received through a positive terminal (+) thereof with a reference voltage (VREF) received through a negative terminal (-) thereof. The voltage divider 312 may divide the power-supply voltage (VDDA). The voltage divider 312 may include a plurality of resistors (R1, R2). The plurality of resistors (R1, R2) may be connected in series between the switching circuit (T1) and an input terminal of the power- supply voltage (VDDA).

The switching circuit (T1) may be connected between the voltage divider 312 and an input terminal of the pumping voltage (PO). The switching circuit (T1) may be controlled by an output signal of the comparator 311, and may output, to a pad (PAD), a negative voltage (NPG) generated by the power-supply voltage (VDDA) and the pumping voltage (PO). Here, the pad (PAD) may be disposed outside the voltage conversion circuit 122, and may be connected to an external capacitor (Cex).

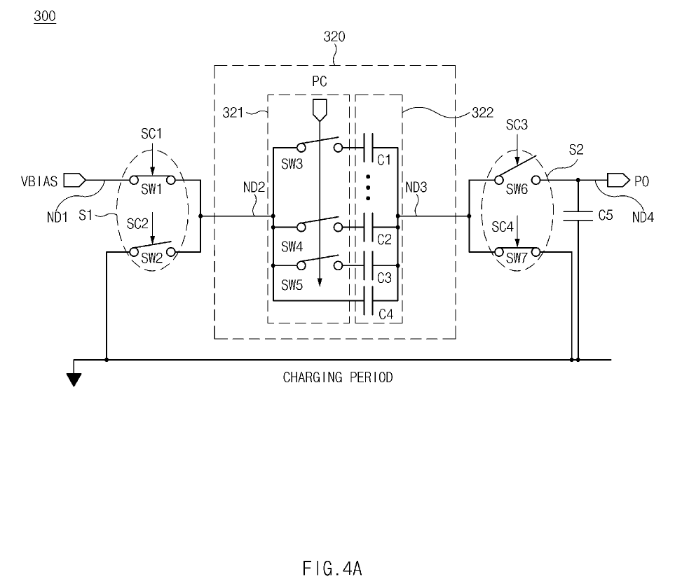

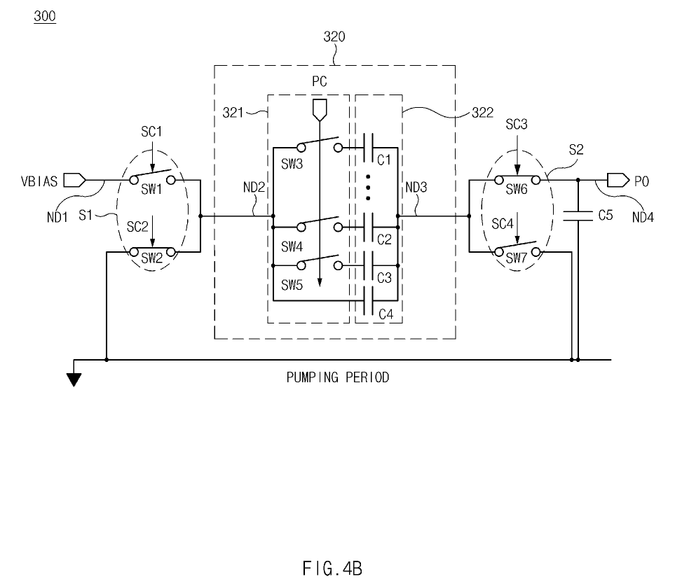

FIGS. 4A and 4B are detailed circuit diagrams illustrating the pump circuit 300 shown in FIG. 3 according to an embodiment of the present disclosure.

FIG. 4A illustrates a charging operation of the pump circuit 300, and FIG. 4B illustrates a pumping operation of the pump circuit 300.

Referring to FIGS. 4A and 4B, the pump circuit 300 may include a first switching circuit (S1), a second switching circuit (S2), a pumping voltage variable circuit 320, and a charge capacitor (C5). The pump circuit 300 may receive a bias voltage (VBIAS) through an input node (ND1), and may output a pumping voltage (PO) through an output node (ND4).

The first switching circuit (S1) may be selectively controlled

to perform a switching operation based on switching control signals (SC1, SC2). Here, the switching control signals (SC1, SC2) may be signals generated by the ISP 126. The switching control signals (SC1, SC2) may be independently activated or deactivated. The first switching circuit (S1) may electrically connect the input node (ND1) to the node (ND2) during a charging period, and may disconnect electrical connection between the input node (ND1) and the node (ND2) during a pumping period.

The first switching circuit (S1) may include a plurality of switches (SW1, SW2). The switch (SW1) may be connected between the input node (ND1) and the node (ND2), and may be controlled by a switching control signal (SC1). The switch (SW2) may be connected between a ground voltage terminal and the node (ND2), and may be controlled by a switching control signal (SC2). For example, the switch (SW1) and the switch (SW2) may operate complementarily to each other.

The second switching circuit (S2) may be selectively controlled to perform a switching operation based on switching control signals (SC3, SC4). Here, the switching control signals (SC3, SC4) may be signals generated by the ISP 126. The switching control signals (SC3, SC4) may be independently activated or deactivated. The second switching circuit (S2) may electrically connect the node (ND3) to the output node (ND4) during a pumping period, and may disconnect electrical connection between the node (ND3) and the output node (ND4) during a charging period.

The second switching circuit (S2) may include a plurality of switches (SW6, SW7). The switch (SW6) may be connected between the node (ND3) and the output node (ND4), and may be controlled by a switching control signal (SC3). The switch (SW7) may be connected between the node (ND3) and a ground voltage terminal, and may be controlled by a switching control signal (SC4). For example, the switch (SW6) and the switch (SW7) may operate complementarily to each other.

The charge capacitor (C5) may be connected between the output node (ND4) and a ground voltage terminal. The charge capacitor (C5) may stabilize the pumping voltage (PO) output through the output node (ND4).

The pumping voltage variable circuit 320 may vary the pumping voltage (PO) by adjusting a pumping capacitance based on a control signal (PC). The pumping voltage variable circuit 320 may include a switching circuit 321 and a capacitance controller 322.

The switching circuit 321 may include a plurality of switches (SW3 to SW5) connected in parallel between the node (ND2) and the capacitance controller 322 so that the switches (SW3 to SW5) can be turned on or off by the control signal (PC). The capacitance controller 322 may include a plurality of pumping capacitors (C1 to C4) connected in parallel between the switching circuit 321 and the node (ND3).

For example, the pumping capacitor (C1) may be connected to the switch (SW3), and the pumping capacitor (C2) may be connected to the switch (SW4). In addition, the pumping capacitor (C3) may be connected to the switch (SW5), and the pumping capacitor (C4) may be connected to the node (ND2).

In FIGS. 4A and 4B, example cases in which one terminal of each of the pumping capacitors (C1 to C3) is connected to a corresponding single switch are illustrated; however, the embodiments of the present disclosure are not limited thereto. In another example, at least one switch may be connected to each of both ends of the pumping capacitors (C1 to C3).

In addition, the number of switches in the switching circuit 321 and the number of pumping capacitors in the capacitance controller 322 shown in FIGS. 4A and 4B are not limited thereto, and may also be sufficiently changed.

The pumping voltage variable circuit 320 may adjust the number of pumping capacitors (C1 to C4) to be charged according to the control signal (PC). As the plurality of switches (SW3 to SW5) is turned on or off according to the control signal (PC), the number of pumping capacitors (C1 to C4) to be used to perform charging and pumping may be adjusted.

The control signal (PC) may be determined based on the intensity of light (e.g., ambient illuminance). For example, when the switching circuit 321 is turned on, at least one pumping capacitor (C1 to C4) connected to the corresponding switch may be charged by the bias voltage (VBIAS). When the switching circuit 321 is turned off, the pumping capacitors (C1 to C4) connected to the corresponding switch may be floated, and may not be charged by the bias voltage (VBIAS).

In response to the control signal (PC), as the intensity of light increases, control may be performed such that a greater number of switches among the plurality of switches (SW3 to SW5) connected to the pumping capacitors (C1 to C4) are turned on. For example, based on the control signal (PC), the voltage conversion circuit 122 may increase the number of pumping capacitors (C1 to C4) to be chargedas the intensity of light increases, thereby increasing the pumping capacitance. Conversely, based on the control signal (PC), the voltage conversion circuit 122 may decrease the number of pumping capacitors (C1 to C4) to be charged as the intensity of light decreases, thereby decreasing the pumping capacitance.

As shown in FIG. 4A, during a charging period, the switch (SW1) of the first switching circuit (S1) may be turned on and the switch (SW2) may be turned off, such that the input node (ND1) and the node (ND2) are connected to each other. Accordingly, the bias voltage (VBIAS) may be transferred to the node (ND2). In addition, the switch (SW6) of the second switching circuit (S2) may be turned off and the switch (SW7) may be turned on, such that a ground voltage is applied to the node (ND3). Accordingly, based on the control signal (PC), the pumping voltage variable circuit 320 may switch the plurality of switches (SW3 to SW5) so that the pumping capacitors (C1 to C4) are charged by the bias voltage (VBIAS).

As shown in FIG. 4B, during a pumping period, the switch (SW2) of the first switching circuit (S1) may be turned on and the switch (SW1) may be turned off, thereby disconnecting the input node (ND1) from the node (ND2). In addition, the switch (SW6) of the second switching circuit (S2) may be turned on and the switch (SW7) may be turned off. Accordingly, a charged voltage of the node (ND3) may be transferred to the output node (ND4). As a result, the pumping voltage (PO) charged in the pumping capacitors (C1 to C4) may be output through the output node (ND4).

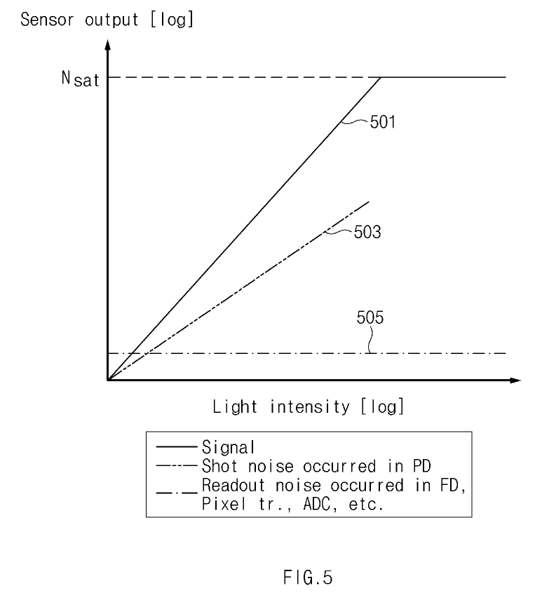

FIG. 5 is a graph illustrating the relationship between noise and a sensor output signal according to the intensity of light according to an embodiment of the present disclosure.

Referring to FIG. 5, the horizontal axis of the graph represents the intensity of light, and the vertical axis represents a sensor output signal.

In FIG. 5, signal output line 501 represents an output of a signal according to the intensity of light, shot noise line 503 represents shot noise according to the intensity of light, and readout noise line 505 represents readout noise according to the intensity of light.

As the intensity of light increases, shot noise in a signal output from the sensor may increase (see, shot noise line 503). Here, probabilistic fluctuations in arrival intervals of charges may occur due to irregular flow of charges (e.g., electrons and holes), resulting in occurrence of shot noise. As the intensity of light increases, the number of incident photons increases, and thus shot noise generated in the photoelectric conversion element (PD) (e.g., a photodiode) may increase.

Readout noise may refer to noise generated in components such as the floating diffusion region (FD), the pixel (PX), the ADC circuit 124, etc., in a process of reading a signal as digital data due to circuit- related factors, and may have a constant value regardless of the intensity of light (see, readout noise line 505).

In a high-illuminance (bright) environment in which the intensity of light is relatively high, shot noise may have a relatively greater impact on performance of the image sensing device than readout noise. For example, as shown when progressing to the right of FIG. 5, the relative sensor output represented by the shot noise line 503 is higher than and increases above the readout noise line 505. Accordingly, the image sensing device 100 according to the present disclosure, in the high-illuminance (bright) environment in which the intensity of light is relatively high, may control the pump circuit 300 to use capacitors (e.g., a larger number of pumping capacitors) having a relatively large capacitance in order to secure high driving capability.

Conversely, in a low-illuminance (dark) environment in which the intensity of light is relatively low, readout noise may have a relatively greater impact on performance of the image sensing device than shot noise. For example, as shown to the left of FIG. 5, the relative sensor output represented by the shot noise line 503 is lower than the readout noise line 505. Accordingly, since the load current is low in the dark environment in which the intensity of light is relatively low, the image sensing device 100 according to the present disclosure may control the pump circuit 300 to use capacitors having a relatively small capacitance (e.g., a smaller number of pumping capacitors) in order to reduce ripple noise.

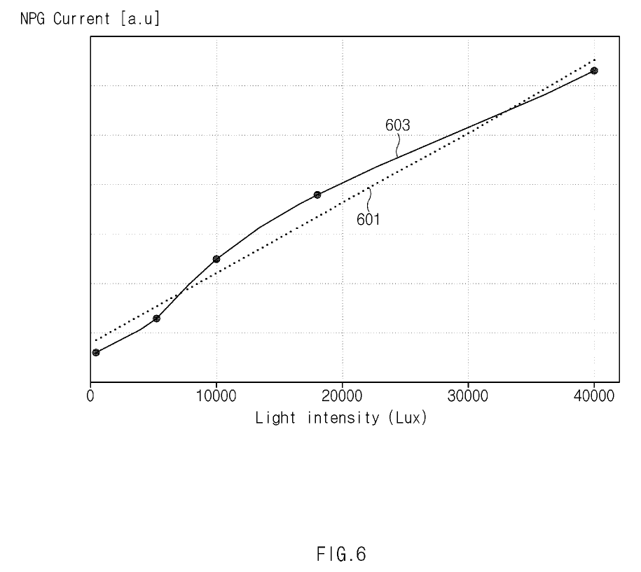

FIG. 6 is a graph illustrating the relationship between negative currents according to the intensity of light when light is incident upon a sensor.

Referring to FIG. 6, the horizontal axis of the graph represents the intensity of light (i.e., Lux), and the vertical axis represents the amount of current flowing to a negative voltage (NPG) node.

In FIG. 6, the dotted line 601 may represent an ideal (e.g., linear) amount of current at the negative voltage node according to the intensity of light, and the solid line 603 may represent a result of measuring the amount of current at the negative voltage node according to the intensity of light in the image sensing device. Here, the negative voltage node may refer to an output terminal at which the negative voltage (NPG) is output, as described above with reference to FIGS. 1 and 3.

For example, in a low-illuminance region, the current at the negative voltage node may decrease compared to the dotted line 601, and in a high-illuminance region, a portion in which the current at the negative voltage node increases compared to the dotted line 601 may occur.

Accordingly, in the image sensing device 100 according to the present disclosure, even when the pumping capacitance (e.g., the number of pumping capacitors) is adaptively adjusted according to the intensity of light, the amount of current (represented by solid line 603) at the negative voltage node according to the intensity of light may be measured to be similar to the ideal amount of current (represented by dotted line 601) at the negative voltage node according to the intensity of light.

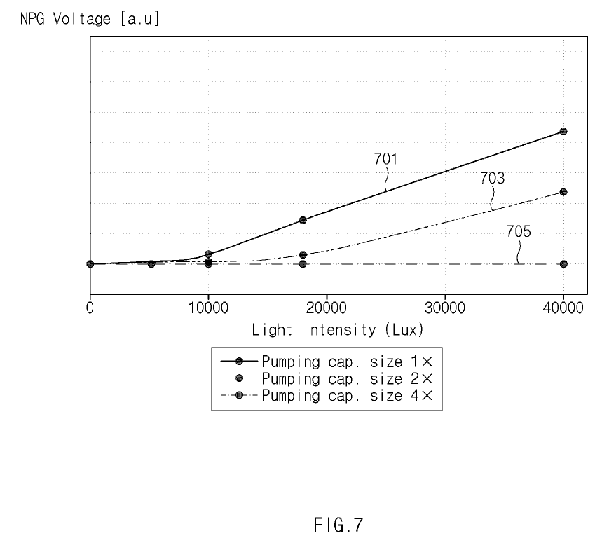

FIG. 7 is a graph illustrating the relationship between the intensity of light and negative voltages (NPG) that change depending on the number of pumping capacitors according to an embodiment of the present disclosure.

Referring to FIG. 7, the horizontal axis of the graph represents the intensity of light (i.e., Lux), and the vertical axis represents a negative voltage (NPG).

In FIG. 7, line 701 represents a change in the negative voltage (NPG) according to the intensity of light when a reference pumping capacitance is used. Line 703 represents a change in the negative voltage (NPG) according to the intensity of light when a pumping capacitance is doubled (2x). Line 705 represents a change in the negative voltage (NPG) according to the intensity of light when a pumping capacitance is quadrupled (4x). As the pumping capacitance increases, the negative voltage (NPG) may be maintained relatively stably regardless of the increasing intensity of light.

The image sensing device 100 according to the present disclosure may variably adjust the pumping capacitance of the pump circuit 300 according to the intensity of light. The ISP 126 may adjust the pumping capacitance of the pump circuit 300 to a value corresponding to a designated threshold when the intensity of light reaches the designated threshold. For example, since the pumping capacitance increases in proportion to the increasing intensity of light, the image sensing device 100 may stably maintain the negative voltage (NPG) even when the intensity of light changes.

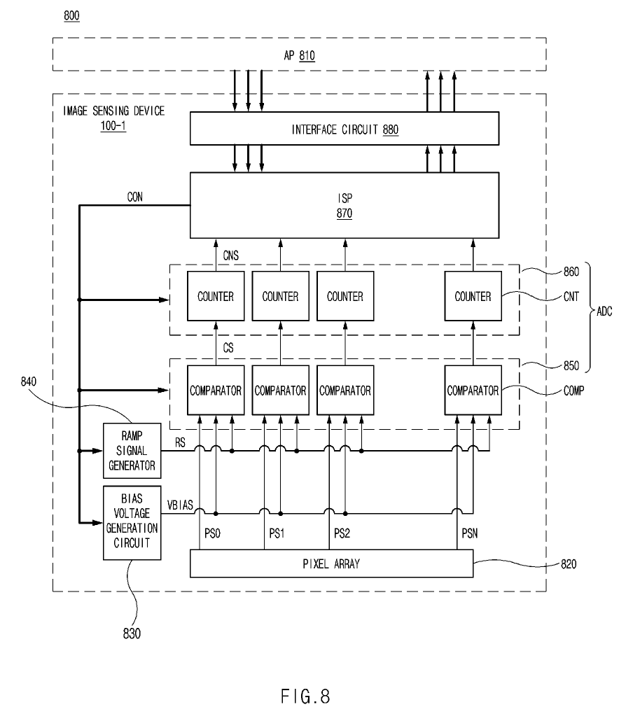

FIG. 8 is a block diagram illustrating an electronic device 800 according to an embodiment of the present disclosure.

Referring to FIG. 8, the electronic device 800 may include a processor (hereinafter referred to as an application processor (AP) 810) and an image sensing device 100-1.

The AP 810 may receive image data processed by an ISP 870 through an interface circuit 880. The AP 810 may identify brightness (i.e., luminance) of the image data. The AP 810 may determine an exposure time and an analog gain of the image sensing device 100-1 based on the luminance of the image data. The AP 810 may transmit exposure time information and analog gain information to the image sensing device 100-1.

The image sensing device 100-1 may include a pixel array 820, a bias voltage generation circuit 830, a ramp signal generator 840, a comparison circuit 850, a counting circuit 860, the ISP 870, and the interface circuit 880. The comparison circuit 850 may include a plurality of comparators (COMP). The counting circuit 860 may include a plurality of counters (CNT).

Here, the pixel array 820 may correspond to the pixel array 111 shown in FIG. 1. The bias voltage generation circuit 830 may correspond to the bias voltage generation circuit 123 described above with reference to FIG. 1. The comparison circuit 850 and the counting circuit 860 may be included in the ADC circuit 124 shown in FIG. 1. The ISP 870 may correspond to the ISP 126 described above with reference to FIG. 1. The interface circuit 880 may correspond to the interface circuit 121 described above with reference to FIG. 1. For simplicity of description, duplicate descriptions overlapping with those of FIGS. 1 to 7 will herein be omitted or briefly described.

The bias voltage generation circuit 830 may generate a bias voltage (VBIAS) by converting a bias current. By way of example, the bias voltage generation circuit 830 may receive a bias current from a bandgap reference circuit (BGR). The bias voltage generation circuit 830 may output the generated bias voltage (VBIAS) to the comparison circuit 850.

The ramp signal generator 840 may generate a ramp signal (RS) based on a control signal (CON) received from the ISP 870, and may transmit the ramp signal (RS) to the comparison circuit 850. For example, the ramp signal (RS) may be a reference signal to be compared with pixel signals (PSO, PS1, PS2, ... , PSN) by the comparison circuit 850, and may be a signal that decreases (or increases) over time.

The comparison circuit 850 may compare pixel signals (PSO, PS1, PS2, ... PSN) output from column lines of the pixel array 820 with the ramp signal (RS) received from the ramp signal generator 840, and may output a comparison signal (CS) based on the result of comparison.

For example, the comparison signal (CS) may be inverted (e.g., may transition from a logic high level to a logic low level or from a logic low level to a logic high level) at a time point when the pixel signals (PSO, PS1, PS2, ... PSN) and the ramp signal (RS) become equal to each other. In addition, the comparison circuit 850 may adjust a bias current based on the bias voltage (VBIAS) received from the bias voltage generation circuit 830.

The counting circuit 860 may perform a counting operation according to a designated clock signal during a time section from a time point where the ramp signal (RS) decreases (or increases) to a time point where the comparison signal (CS) is inverted. The counting circuit 860 may output a counting signal (CNS) corresponding to a result of the counting operation to the ISP 870. Here, the counting signal (CNS) may correspond to a value obtained by converting an analog pixel signal into a digital value. The counting circuit 860 may be initialized according to a reset control signal received from the ISP 870.

The ISP 870 may control overall operations of the image sensing device 100-1. For example, the ISP 870 may transmit a control signal (CON) to the bias voltage generation circuit 830, the ramp signal generator 840, the comparison circuit 850, and/or the counting circuit 860. The ISP 870 may adjust brightness (luminance) of image data based on exposure time information and analog gain information received from the AP 810. For example, the ISP 870 may drive pixels of the pixel array 820 based on the exposure time information.

The ISP 870 may generate at least one control signal (CON) based on analog gain information. The ISP 870 may adjust a bias current of the comparator (COMP) of the comparison circuit 850 through the control signal (CON). For example, when the analog gain is relatively high, the ISP 870 may adjust the bias current of the comparator (COMP) to a relatively high value. Conversely, when the analog gain is relatively low, the ISP 870 may adjust the bias current of the comparator (COMP) to a relatively low value.

The interface circuit 880 may perform data (e.g., image data, exposure time information, and/or analog gain information) communication between the AP 810 and the image sensing device 100- 1.

The configuration of the image sensing device 100-1 is not limited to that illustrated in FIG. 8, and at least some components may be omitted or at least one component may be added.

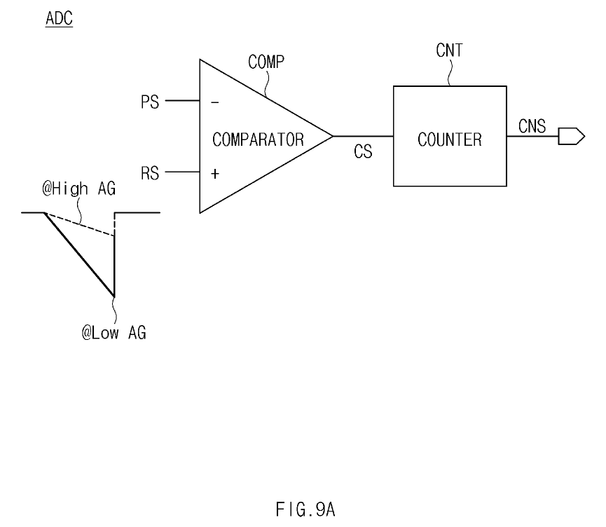

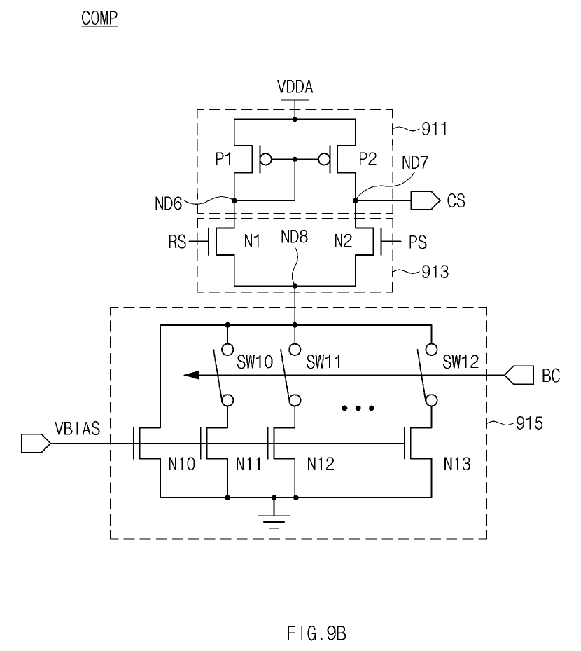

FIG. 9A is a circuit diagram illustrating the analog-to-digital conversion (ADC) circuit shown in FIG. 8 according to an embodiment of the present disclosure. As shown in FIG. 8, the ADC circuit includes the comparison circuit 850 and the counting circuit 860.

Referring to FIG. 9A, one comparator (COMP) and one counter (CNT) are illustrated in the analog-to-digital conversion (ADC) circuit (denoted by 'ADC' in FIG. 9A).

The comparator (COMP) may compare a pixel signal (PS) with a ramp signal (RS). The comparator (COMP) may transmit, to the counter (CNT), a comparison signal (CS), which represents a comparison result between the pixel signal (PS) and the ramp signal (RS).

Here, the ramp signal (RS) may exhibit different waveforms based on an analog gain (AG). That is, when the analog gain (AG) is relatively large, the ramp signal (RS) may have a relatively gentle slope, and when the analog gain (AG) is relatively small, the ramp signal (RS) may have a relatively steep slope.

The comparator (COMP) may output the comparison signal (CS) at a logic low level (or a logic high level) when the pixel signal (PS) is greater than the ramp signal (RS). Conversely, when the pixel signal (PS) is smaller than the ramp signal (RS), the comparator (COMP) may output the comparison signal (CS) at a logic high level (or a logic low level). When the pixel signal (PS) and the ramp signal (RS) are equal to each other, the logic level of the comparison signal (CS) may be inverted.

The structure of the comparator (COMP) included in the ADC circuit (ADC) is not limited to that illustrated in FIG. 9A, and may be replaced with various comparator structures capable of determining a difference between the pixel signal (PS) and the ramp signal (RS).

In addition, the counter (CNT) may perform a counting operation according to a designated clock signal. The counter (CNT) may perform the counting operation until the ramp signal (RS) matches the analog pixel signal (PS). The counter (CNT) may stop the counting operation based on the comparison signal (CS) when the pixel signal (PS) becomes equal to the ramp signal (RS).

FIG. 9B is a detailed circuit diagram illustrating the comparator (COMP) shown in FIG. 9A according to an embodiment of the present disclosure.

Referring to FIG. 9B, the comparator (COMP) may include a driver 911, a differential comparator 913, and a bias adjustment circuit 915.

The driver 911 may selectively supply the power-supply voltage (VDDA) based on a voltage level of the node (ND6). The driver 911 may include a plurality of p-channel metal-oxide-semiconductor (PMOS) transistors (P1, P2). The PMOS transistors (P1, P2) may operate as loads, and may convert a current difference between the nodes (ND6, ND7) into a voltage. The PMOS transistor (P1) may be connected between the node (ND6) and the power-supply voltage (VDDA) input terminal, and the PMOS transistor (P2) may be connected between the node (ND7) and the power-supply voltage (VDDA) input terminal, so that a common gate terminal of the PMOS transistors (P1, P2) may be connected to the node (ND6).

The differential comparator 913 may differentially compare the ramp signal (RS) with the pixel signal (PS), and may output a comparison signal (CS) based on a result of the comparison through the node (ND7). The differential comparator 913 may include a plurality of n-channel metal-oxide-semiconductor (NMOS) transistors (N1, N2). The NMOS transistor (N1) may be connected between the node (ND6) and the node (ND8), and may receive the ramp signal (RS) through a gate terminal thereof. The NMOS transistor (N2) may be connected between the node (ND7) and the node (ND8), and may receive the pixel signal (PS) through a gate terminal thereof.

The bias adjustment circuit 915 may adjust a bias current corresponding to the bias voltage (VBIAS) based on a bias current control signal (BC) received from the ISP 870. Here, the bias current control signal (BC) may correspond to the control signal (CON) described above.

The bias adjustment circuit 915 may include a plurality of switches (SW10 to SW12) and a plurality of NMOS transistors (N10 to N13).

Here, the plurality of switches (SW10 to SW12) may be connected in parallel between the node (ND8) and the plurality of NMOS transistors (N11 to N13). The plurality of switches (SW10 to SW12) may be selectively switched based on the bias current control signal (BC).

The NMOS transistor (N10) may be connected between the node (ND8) and a ground voltage terminal, and may receive the bias voltage (VBIAS) through a gate terminal thereof. In addition, the plurality of NMOS transistors (N11 to N13) may be connected between the ground voltage terminal and the switches (SW10 to SW12), and may receive the bias voltage (VBIAS) through gate terminals thereof.

For example, when a selected one among the switches (SW10 to SW12) is turned on, the NMOS transistor connected to the selected switch may generate a bias current. Conversely, when a selected one among the switches (SW10 to SW12) is turned off, the NMOS transistor connected to the selected switch may not generate a bias current.

A bias current of the comparator (COMP) may be generated through NMOS transistors (N11 to N13) corresponding to the number of switches turned on among the plurality of switches (SW10 to SW12). For example, based on the bias current control signal (BC), the comparator (COMP) may turn on a greater number of switches to generate a larger bias current in a relatively high analog gain environment, and may turn on a smaller number of switches to generate a smaller bias current in a relatively low analog gain environment.

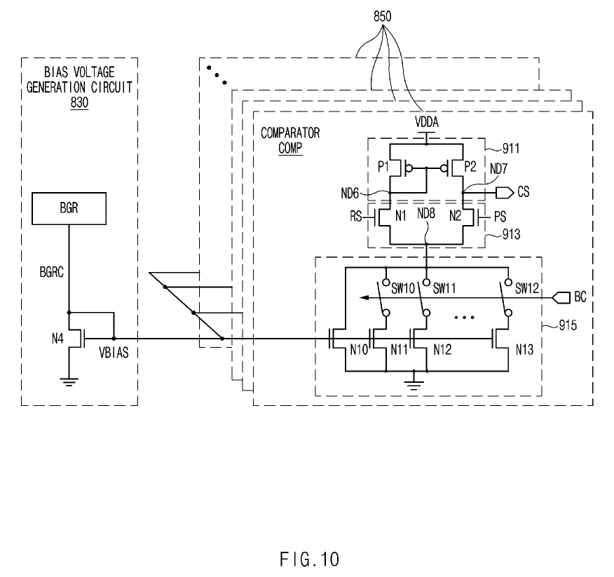

FIG. 10 is a circuit diagram illustrating a bias voltage generation circuit 830 and a comparison circuit 850 shown in FIG. 8 according to an embodiment of the present disclosure. Hereinafter, descriptions overlapping with those of FIGS. 8, 9A, and 9B will be omitted or briefly described.

Referring to FIG. 10, the bias voltage generation circuit 830 may generate a bias voltage (VBIAS), and output the bias voltage (VBIAS) to comparators (COMPs) of the ADC circuit (ADC). The bias voltage generation circuit 830 may include a bandgap reference circuit (BGR) and an NMOS transistor (N4).

Here, the bandgap reference circuit (BGR) may generate a reference current (BGRC). The NMOS transistor (N4) may be connected between a ground voltage terminal and an input terminal of the reference current (BGRC), and a gate terminal and a drain terminal of the NMOS transistor (N4) may be commonly connected to each other. The NMOS transistor (N4) may convert the reference current (BGRC) into a bias voltage (VBIAS). The bias voltage (VBIAS) may be output to each comparator (COMP) of the comparison circuit 850.

The bias current control signal (BC) of the comparator (COMP) may be determined based on an analog gain value. Accordingly,

the bias adjustment circuit 915 may adjust the bias current of the comparator (COMP) based on the analog gain. For example, the bias adjustment circuit 915 may increase the bias current when the analog gain (AG) increases, and may decrease the bias current when the analog gain decreases.

That is, by using a lower bias current in a low analog gain environment than in a high analog gain environment, a voltage margin of a transistor may be secured. Conversely, by using a higher bias current in a high analog gain environment than in a low analog gain environment, noise occurring in a dark environment may be reduced.

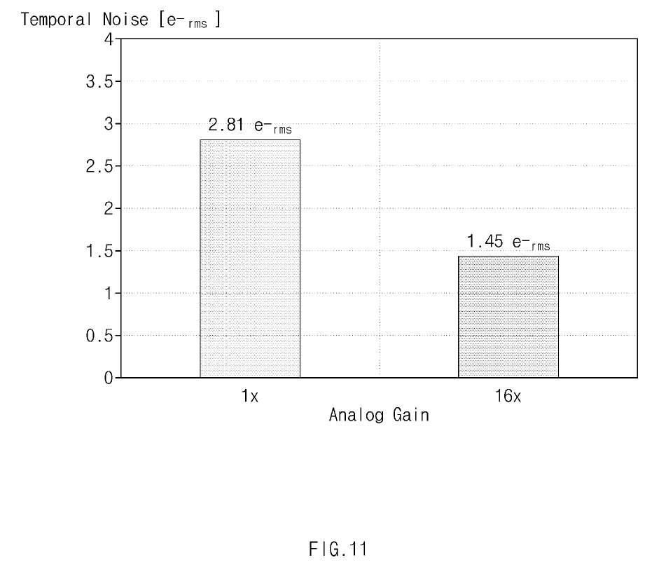

FIG. 11 is a graph illustrating the relationship between temporal noise and analog gain according to an embodiment of the present disclosure.

Referring to FIG. 11, the horizontal axis of the graph represents an analog gain, and the vertical axis of the graph represents temporal noise.

By way of example, noise components included in image data generated by the image sensing device 100-1 may include fixed pattern noise and/or temporal noise.

Here, fixed pattern noise may refer to noise having a constant pattern due to hardware characteristics (e.g., lens shading) of the image sensing device 100-1. Temporal noise, which is distinguished from fixed pattern noise, may refer to noise that varies over time. That is, temporal noise may be noise that occurs randomly without a fixed pattern, and may include photon shot noise, dark current noise, read noise, and the like. Photon shot noise may occur in the presence of light, dark current noise may occur in the absence of light, and both photon shot noise and dark current noise may include noise generated during a readout operation within the image sensor.

Referring to the graph of FIG. 11, as the analog gain increases, temporal noise may decrease (for example, temporal noise of 1.45 e-rms at analog gain of 16x), and as the analog gain decreases, temporal noise may increase (for example, temporal noise of 2.81 e- rms at analog gain of 1x).

In a situation in which the analog gain is relatively low, the ramp signal (RS) may swing widely and be applied to the comparator (COMP), making it difficult to secure a voltage margin of transistors. On the other hand, when the analog gain is relatively high, quantization noise among temporal noises may have a relatively large effect on image data, whereas thermal noise among temporal noises may have a relatively small effect on the image data.

In a situation in which the analog gain is relatively low, temporal noise may increase due to occurrence of quantization noise. In this case, since the size of a ramp step of the ramp signal (RS) is relatively large, a bandwidth requirement of the comparator (COMP) may also be reduced. Accordingly, the image sensing device 100-1 according to the present disclosure may secure a voltage margin of a transistor by more significantly reducing a bias current of the comparator (COMP) in a low analog gain environment compared to that in a high analog gain environment.

Conversely, the image sensing device 100-1 according to the present disclosure may increase the bias current of the comparator (COMP) in a situation in which the analog gain is relatively high, so that the bias current of the comparator (COMP) may be increased to reduce noise in a dark environment in which the intensity of light is low. As the bias current of the comparator (COMP) increases in a high analog gain environment compared to a low analog gain environment, the image sensing device 100-1 may reduce noise occurring in the dark environment.

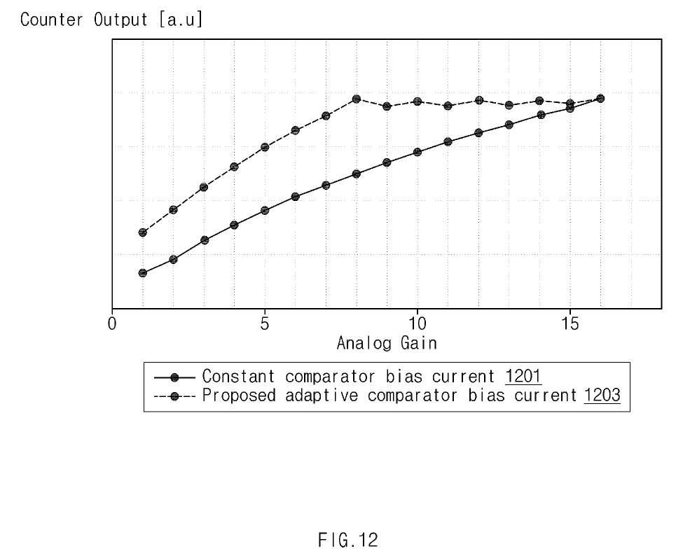

FIG. 12 is a graph illustrating the relationship between analog gain and counter output signals according to an embodiment of the present disclosure.

Referring to FIG. 12, the horizontal axis of the graph represents an analog gain, and the vertical axis represents an output of a counter (CNT) of the ADC circuit. In FIG. 12, a solid line 1201 may represent a counter (CNT) output when a bias current of the comparator (COMP) is fixed, and a dashed line 1203 represents a counter (CNT) output when the bias current of the comparator (COMP) is adjusted according to the analog gain.

In the present disclosure, when the bias current of the comparator (COMP) is adaptively adjusted according to the analog gain, it can be confirmed that the output of the counter (CNT) increases compared to a case in which the bias current of the comparator (COMP) is fixed.

The image sensing device 100-1 according to the present disclosure may increase a bias current of the comparator (COMP) when an analog gain is relatively low, and may decrease the bias current of the comparator (COMP) when the analog gain is relatively high. When the bias current of the comparator (COMP) is set to be relatively large in a situation where the analog gain is relatively low, noise and/or a counting time may be reduced. When the bias current of the comparator (COMP) is set to be relatively small in a situation where the analog gain is relatively high, power consumption of the image sensing device may be reduced.

As is apparent from the above description, the voltage conversion circuit and the image sensing device including the same according to the embodiments of the present disclosure may adaptively control the magnitude of a pumping capacitance of a voltage conversion circuit according to the intensity of light, thereby securing high driving capability in a high-illuminance (or bright) environment and minimizing output ripples of the voltage conversion circuit in a low-illuminance (or dark) environment.

The image sensing device according to the embodiments of the present disclosure may secure a voltage margin according to an analog gain and reduce temporal noise by adjusting a bias current of the ADC circuit based on an analog gain of a pixel signal.

The embodiments of the present disclosure may provide a variety of effects capable of being directly or indirectly recognized through the above-mentioned patent document.

Those skilled in the art will appreciate that the present disclosure may be carried out in other specific ways than those set forth herein. In addition, claims that are not explicitly presented in the appended claims may be presented in combination as an embodiment or included as a new claim by a subsequent amendment after the application is filed.

Although a number of illustrative embodiments have been described, it should be understood that modifications and enhancements to the disclosed embodiments and other embodiments can be devised based on what is described and/or illustrated in this patent document.

What is claimed is:

1. A voltage conversion circuit comprising:
a pump circuit configured to pump a bias voltage and generate a
pumping voltage; anda regulator configured to regulate the pumping voltage and generate an output voltage,wherein the pump circuit is configured to vary the pumping voltage by adjusting a pumping capacitance based on an intensity of
light.

2. The voltage conversion circuit according to claim 1, wherein:
the pump circuit is controlled to increase the pumping capacitance as the intensity of light increases; and
the pump circuit is controlled to decrease the pumping capacitance as the intensity of light decreases.

3. The voltage conversion circuit according to claim 1, wherein the pump circuit includes:
a first switching circuit configured to selectively supply the bias voltage to a first node based on first switching control signals;
a pumping voltage variable circuit configured to charge and pump the bias voltage received through the first node and to output the pumping voltage to a second node; and
a second switching circuit configured to selectively control an output of the pumping voltage based on second switching control signals.

4. The voltage conversion circuit according to claim 3, wherein the pump circuit is configured to adjust the pumping capacitance based on a control signal, which is controlled based on the intensity of light.

5. The voltage conversion circuit according to claim 3, wherein
the first switching circuit includes:a first switch connected between an input terminal of the bias voltage and the first node; anda second switch connected between the first node and a ground voltage terminal.

6. The voltage conversion circuit according to claim 5, wherein the first switching circuit is configured to:
during a charging period, turn on the first switch and turn off the second switch to output the bias voltage to the first node; and
during a pumping period, turn on the second switch and turn off the first switch to block connection between an input terminal of the bias voltage and the first node.

7. The voltage conversion circuit according to claim 5, wherein
the second switching circuit includes:a third switch connected between the second node and an output terminal of the pumping voltage; anda fourth switch connected between the second node and the
ground voltage terminal.

8. The voltage conversion circuit according to claim 7, wherein the second switching circuit is configured to:
during a charging period, turn on the fourth switch and turn off
the third switch to block connection between the second node and the output terminal of the pumping voltage; andduring a pumping period, turn on the third switch and turn off the fourth switch to connect the second node to the output terminal of the pumping voltage.

9. The voltage conversion circuit according to claim 7, wherein the pumping voltage variable circuit includes:
a switching circuit including multiple switches that are connected in parallel to the first node and are selectively switched based on a
control signal, which is controlled based on the intensity of light; anda capacitance controller including multiple pumping capacitors connected between the second node and the multiple switches.

10. The voltage conversion circuit according to claim 9, wherein
the pumping voltage variable circuit is configured to:selectively switch the multiple switches based on the control signal, to adjust the number of the pumping capacitors to be charged among the plurality of pumping capacitors.

11. The voltage conversion circuit according to claim 3, wherein the pump circuit further includes:
a charge capacitor connected between a ground voltage terminal and an output terminal of the pumping voltage.

12. An image sensing device comprising:
a pixel array configured to output a pixel signal corresponding to an incident light;
a voltage conversion circuit configured to charge and pump a bias
voltage to generate a pumping voltage, and configured to vary the pumping voltage by adjusting a pumping capacitance according to a control signal;an analog-to-digital conversion (ADC) circuit configured to sample and hold the pixel signal, convert the pixel signal into a digital signal, and output the digital signal; andan image signal processor configured to control the control signal in response to an intensity of the incident light.

13. The image sensing device according to claim 12, wherein
the voltage selection circuit is configured to:generate a negative voltage using the pumping voltage; andprovide the negative voltage to the pixel array.

14. The image sensing device according to claim 12, wherein the image signal processor is configured to:
estimate the intensity of light based on at least one of an average value of the pixel signal, an exposure time, and an analog gain of the pixel signal; and
control the control signal based on the estimated intensity of light.

15. The image sensing device according to claim 12, wherein:
the voltage conversion circuit includes a pump circuit configured to pump the bias voltage to generate the pumping voltage, and adjust
the pumping capacitance according to the control signal;the pump circuit is controlled to increase the pumping capacitance as the intensity of light increases; andthe pump circuit is controlled to decrease the pumping capacitance as the intensity of light decreases.

16. The image sensing device according to claim 12, wherein the image signal processor is configured to:
adjust a bias current of the ADC circuit based on an analog gain for the pixel signal.

17. The image sensing device according to claim 16, wherein the image signal processor is configured to:
control the ADC circuit to increase the bias current as the analog
gain increases.

18. The image sensing device according to claim 17, wherein the ADC circuit includes:
a comparator configured to generate a comparison signal by
comparing a ramp signal with the pixel signal; anda counter configured to perform a counting operation based on the comparison signal.

19. The image sensing device according to claim 18, wherein
the comparator includes:a driver configured to selectively supply a power-supply voltage based on a voltage level of a first node;a differential comparator configured to compare the ramp signal with the pixel signal and to output the comparison signal to a second
node; anda bias adjustment circuit configured to control the bias current by adjusting a number of transistors to be used based on a bias current control signal.

20. The image sensing device according to claim 19, wherein the image signal processor is configured to:
control the bias current control signal based on the analog gain.
